(19) United States
(12) Patent Application Publication
(10) Pub. No.: US 2026/0218629 A1
(43) Pub. Date: Jul. 30, 2026

(54) CONTAINMENT RING FOR GAS TURBINE ENGINE

(71) Applicant: Pratt & Whitney Canada Corp., Longueuil, Québec (CA)

(72) Inventors: Nathan Tomes, Hamilton, Ontario (CA); Piotr Szczesnowicz, Toronto, Ontario (CA)

(21) Appl. No.: 19/036,866

(22) Filed: Jan. 24, 2025

(51) Int. Cl. F01D 25/24; F01D 25/00

(52) U.S. Cl. CPC F01D 25/24; F01D 25/005

(57) ABSTRACT

A casing for a gas turbine engine, including: a containment fabric layer wrapped around a structural shell; and a bi-material shell located around the containment fabric layer, the bi-material shell formed from a plurality of bi-material shell segments, each of the plurality of bi-material shell segments include an inner layer and an outer layer, the outer layer comprises a plurality of individual segments that form the outer layer and a plurality of embedded fuse lines defined by the plurality of individual segments of the outer layer, wherein an overall structure of the bi-material shell does not impede a rapid expansion of the containment fabric layer.

### BACKGROUND

This disclosure relates to gas turbine engines, and more particularly to a containment ring for a gas turbine engine.

Gas turbine engines include rotating blades. In the event of a failure of any of the rotating blades it is desirable to contain the dislodged blade within the engine.

As such, it is desirable to provide an apparatus and method for blade containment in a gas turbine engine.

### BRIEF DESCRIPTION

Disclosed is a casing for a gas turbine engine, including: a containment fabric layer wrapped around a structural shell; and a bi-material shell located around the containment fabric layer, the bi-material shell formed from a plurality of bi-material shell segments, each of the plurality of bi-material shell segments include an inner layer and an outer layer, the outer layer comprises a plurality of individual segments that form the outer layer and a plurality of embedded fuse lines defined by the plurality of individual segments of the outer layer, wherein an overall structure of the bi-material shell does not impede a rapid expansion of the containment fabric layer.

In addition to one or more of the features described above, or as an alternative to any of the foregoing embodiments, the inner layer of each of the plurality of bi-material shell segments is continuous.

In addition to one or more of the features described above, or as an alternative to any of the foregoing embodiments, the inner layer of each of the plurality of bi-material shell segments contains lap joints.

In addition to one or more of the features described above, or as an alternative to any of the foregoing embodiments, the plurality of embedded fuse lines are defined by anyone of the following; butt joints between the plurality of individual segments that form the outer layer, overlap joints between the plurality of individual segments that form the outer layer, fiber discontinuities between the plurality of individual segments that form the outer layer or combinations thereof.

In addition to one or more of the features described above, or as an alternative to any of the foregoing embodiments, the inner layer comprises polyvinyl fluoride and the plurality of individual segments that form the outer layer are carbon fiber-reinforced polymer segments.

In addition to one or more of the features described above, or as an alternative to any of the foregoing embodiments, the plurality of embedded fuse lines are defined by wavy lines.

In addition to one or more of the features described above, or as an alternative to any of the foregoing embodiments, the plurality of embedded fuse lines are defined by zig zag fuse lines.

In addition to one or more of the features described above, or as an alternative to any of the foregoing embodiments, a fiber orientation of each of the plurality of individual segments that form the outer layer minimize a longest fiber length while minimizing a number of the plurality of individual segments.

In addition to one or more of the features described above, or as an alternative to any of the foregoing embodiments, a fiber orientation of each of the plurality of individual segments that form the outer layer are 45 degrees to parallel fuse lines.

In addition to one or more of the features described above, or as an alternative to any of the foregoing embodiments, the casing is a fan casing.

Also disclosed is a gas turbine engine, including: a fan having a plurality of fan blades; a casing surrounding the plurality of fan blades, the casing including: a containment fabric layer wrapped around a structural shell; and a bi-material shell located around the containment fabric layer, the bi-material shell formed from a plurality of bi-material shell segments, each of the plurality of bi-material shell segments include an inner layer and an outer layer, the outer layer comprises a plurality of individual segments that form the outer layer and a plurality of embedded fuse lines defined by the plurality of individual segments of the outer layer, wherein an overall structure of the bi-material shell does not impede a rapid expansion of the containment fabric layer.

In addition to one or more of the features described above, or as an alternative to any of the foregoing embodiments, the inner layer of each of the plurality of bi-material shell segments is continuous.

In addition to one or more of the features described above, or as an alternative to any of the foregoing embodiments, the inner layer of each of the plurality of bi-material shell segments contains lap joints.

In addition to one or more of the features described above, or as an alternative to any of the foregoing embodiments, the plurality embedded fuse lines are defined by anyone of the following; butt joints between the plurality of individual segments that form the outer layer, overlap joints between the plurality of individual segments the form the outer layer, fiber discontinuities between the plurality of individual segments that form the outer layer or combinations thereof.

In addition to one or more of the features described above, or as an alternative to any of the foregoing embodiments, the inner layer comprises polyvinyl fluoride and the plurality of individual segments that form the outer layer are carbon fiber-reinforced polymer segments.

In addition to one or more of the features described above, or as an alternative to any of the foregoing embodiments, the plurality of embedded fuse lines are defined by wavy lines.

In addition to one or more of the features described above, or as an alternative to any of the foregoing embodiments, the plurality of embedded fuse lines are defined by zig zag fuse lines.

In addition to one or more of the features described above, or as an alternative to any of the foregoing embodiments, a fiber orientation of each of the plurality of individual segments that form the outer layer minimize a longest fiber length while minimizing a number of the plurality of individual segments.

In addition to one or more of the features described above, or as an alternative to any of the foregoing embodiments, a fiber orientation of each of the plurality of individual segments that form the outer layer are 45 degrees to parallel fuse lines.

### BRIEF DESCRIPTION OF THE DRAWINGS

The following descriptions should not be considered limiting in any way. With reference to the accompanying drawings, like elements are numbered alike:

FIG. 1 is a schematic, partial cross-sectional view of a gas turbine engine in accordance with the present disclosure;

FIG. 2 is a partial perspective cross-sectional view of a fan case in accordance with the present disclosure;

FIG. 2A is cross-sectional view of a bi-material shell section in accordance with the present disclosure;

FIG. 2B is cross-sectional view of a plurality of bi-material shell sections located about an axis of a gas turbine engine in accordance with the present disclosure;

FIGS. 2C and 2D are cross-sectional views of a bi-material shell sections located about an axis of a gas turbine engine in accordance with the present disclosure;

FIG. 3 is a schematic cross-sectional view of a portion of a steel support structure shell of sheet metal, used in the fan case of FIG. 1;

FIGS. 4-9 illustrate various fuse line patterns of an outer layer of a bi-material shell in accordance with the present disclosure; and

FIGS. 10-15 illustrate an outer layer of a bi-material shell in accordance with an alternative embodiment of the present disclosure.

### DETAILED DESCRIPTION

A detailed description of one or more embodiments of the disclosed apparatus and method are presented herein by way of exemplification and not limitation with reference to the FIGS.

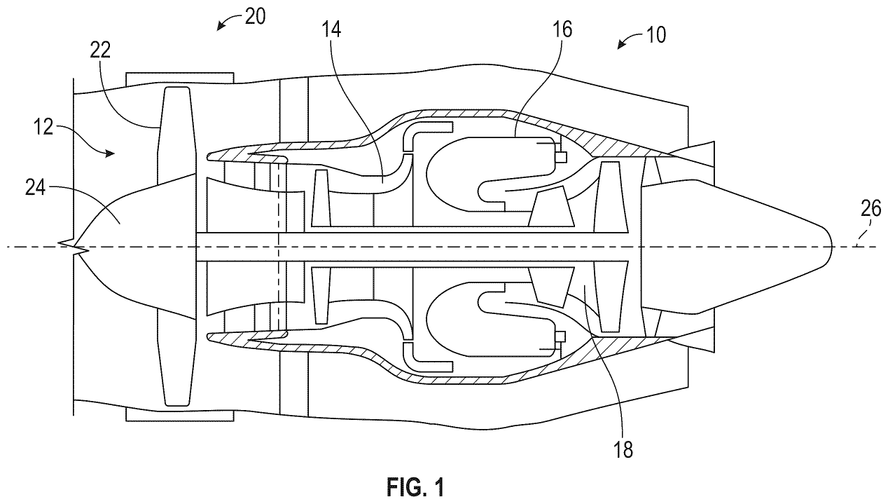

FIG. 1 illustrates a turbofan gas turbine engine 10 of a type provided for use in subsonic flight, generally comprising in serial flow communication a fan 12 through which ambient air is propelled, a multi-stage compressor 14 for pressurizing the air, a combustor 16 in which the compressed air is mixed with fuel and ignited for generating an annular stream of hot combustion gases, and a turbine section 18 for extracting energy from the combustion gases. The fan 12 includes a fan case 20 surrounding a circumferential array of fan blades 22 extending radially outwardly from a rotor 24 mounted for rotation about a central axis 26 of the engine 10.

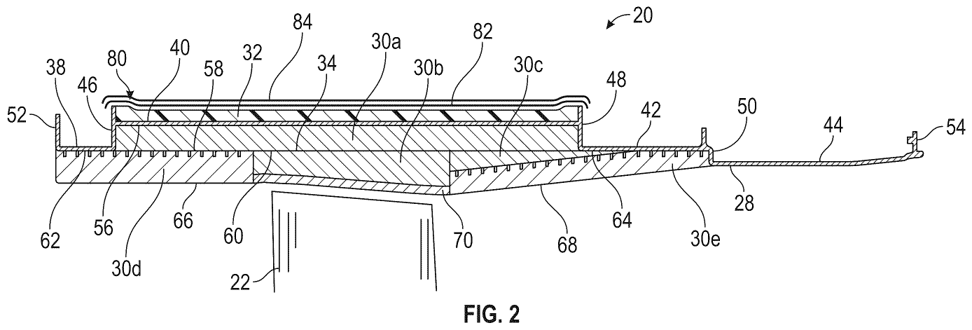

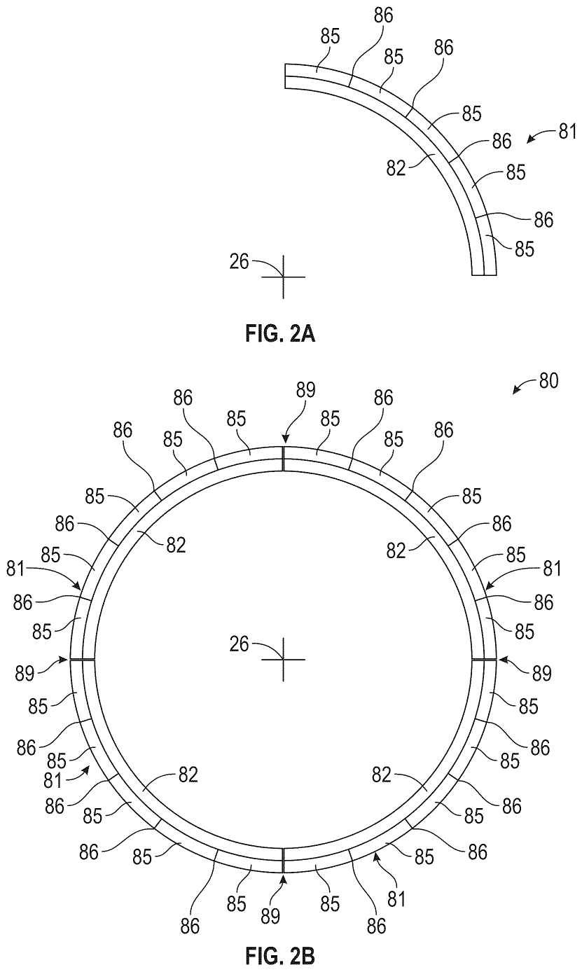

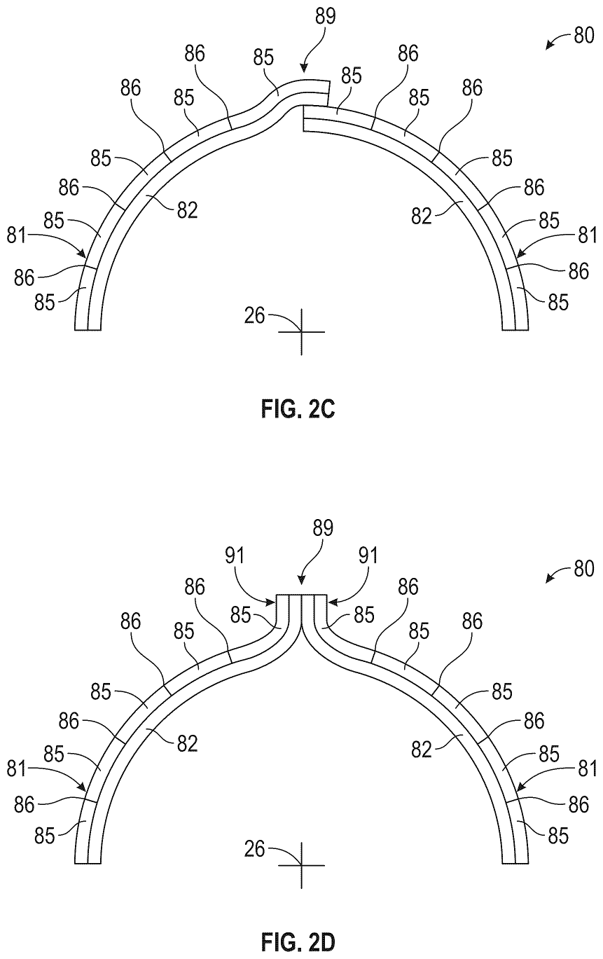

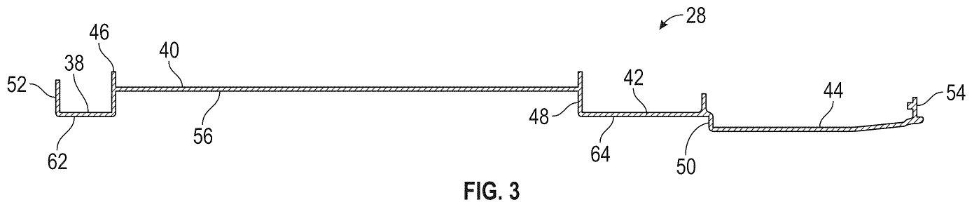

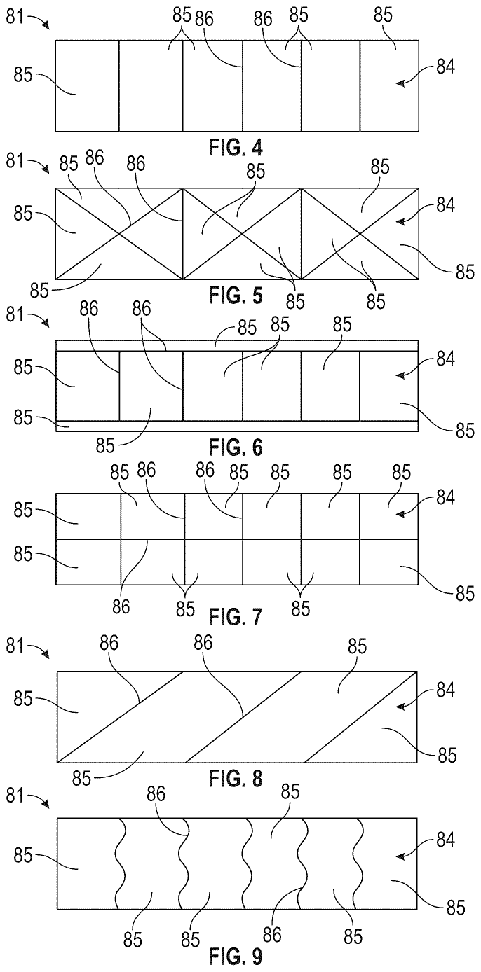

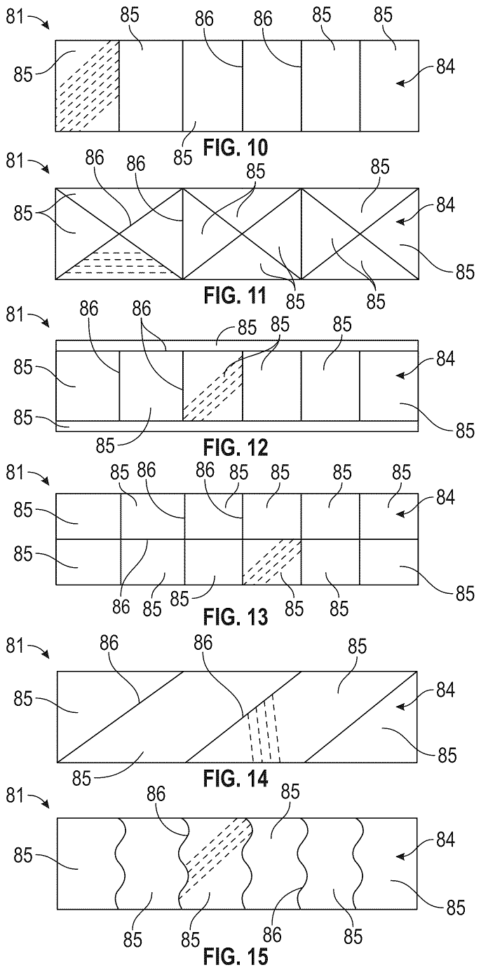

As shown in FIGS. 2 and 3, the fan case 20 according to one non-limiting embodiment of the present disclosure has an annular soft wall sandwich structure designed for containing blade fragments or blades during a fan blade-off (FBO) event. As will be seen hereinafter, the described embodiment allows minimizing of the outside diameter and weight of the fan case while still providing the required blade containment capability and the required structural stiffness and strength.

It should be noted that the terms “radial”, “axial” and “circumferential” used throughout the description and the appended claims, are defined with respect to the central axis 26 of the engine 10. The terms “front”, “forward” “afore”, “aft” and after” used throughout the description and the appended claims are defined with respect to the flow direction of air being propelled through the engine.

As used herein, “integral” or “integrally formed” is intended to cover a single unitary structure. In other words, the single unitary structure is not capable of being disassembled without cutting or destruction of the single unitary structure.

In one non-limiting example, the fan 12 includes a plurality of fan blades 22. It is necessary to retain high energy debris resulting from a blade failure of any stage in the gas turbine engine 10 and this debris must be contained within the engine. In the case of a fan blade off, there are at least two dominant methods of achieving the containment of the fan blades 22. These may be referred to as hard wall and soft wall.

Soft wall containment relies on a multi-layered belt of dry KEVLAR to contain the fan blade. As is known in the related arts KEVLAR is a manufactured polymer, made of a chemical compound called poly-para-phenylene terephthalamide. KEVLAR is a type of aramid fiber and it woven into textile materials. The blade is allowed to pass through the structure of the fan cases (often a lightweight sandwich structure) and hit the KEVLAR. The KEVLAR belts slip and stretch significantly while absorbing the blade's kinetic energy, causing a large bulge. The longer distance across which the blade travels during containment means that the peak force on the fan case is lower compared to hardwall containment, and the belt effectively redistributes the containment force around the circumference of the case. These effects together usually allow the fan case and adjacent structure to be lighter compared to hardwall containment. In addition, because the released blade exits the gaspath entirely, it only briefly interacts with the remaining fan blades, allowing further weight reduction. While prediction of the released blade trajectory is not trivial in soft wall containment, it is less chaotic than hardwall systems because following containment the blade is trapped between the case structure and the KEVLAR belt.

As mentioned above, soft wall containment involves using a light weight, weak fan case structure wrapped in a multi-layer dry KEVLAR belt. This design system allows a released blade to pass through the structure and impact the KEVLAR belt, which absorbs the majority of the kinetic energy and redistributes the containment forces around the circumference of the fan case structure. Dry KEVLAR could be damaged by freeze-thaw cycles, ultraviolet light, handling damage and other environmental hazards, so the wrap requires a protective layer. It is possible to utilize a rigid, strong layer to protect the KEVLAR, such as a pre-preg fiberglass ring, but if it is too strong, this design can cause the KEVLAR to be pinched between the blade and the protective ring and be less effective than if the belt was freely able to expand. A possible solution would be to utilize a Polytetrafluoroethylene (PTFE) wrap, which is flexible and relatively weak. This allows the KEVLAR to expand freely under fan blade off loading. The drawback is that the PTFE wrap is difficult to bond, prone to handling damage, and unsightly to repair. Since this part is on the outside of the engine, customers prefer a solution that is aesthetically pleasing, even when repaired.

The fan case 20 generally includes a structural shell 28, which in one non-limiting embodiment may be a thin-walled steel support structure shell 28. Alternatively, the structural shell 28 is formed from aluminum or composites or any other material providing the desired structural shell. The fan case in one non-limiting embodiment may also include honeycomb materials 30a, 30b, 30c, 30d and 30e which may be light weight, forming a honeycomb material layer bonded or otherwise suitably secured to a radially inner side of the thin-walled steel support structure shell 28; a thin-walled annular metallic inner axial wall 34, such as an aluminum wall, positioned within the thin-walled support structure shell 28 and embedded in the honeycomb material layer and bonded or otherwise suitably secured to the thin-walled support structure shell 28; and an outer containment fabric layer 32 wrapped around the structural shell 28.

In one non-limiting embodiment, the thin-walled steel support structure shell 28 is provided in the form of a one-piece continuous annular steel component, for example, made of sheet metal selected from a thickness range of between 0.02 and 0.07 inches. In order to improve the structural stiffness and strength of such a thin-walled shell configuration, the thin-walled steel support structure shell 28 may include a plurality of axial sections arranged in an axial series and having different diameters, and a plurality of radially extending rings 46, 48 and 50 which may be of forged steel, to radially interconnect first, second, third and fourth annular axial walls 38, 40, 42 and 44 in adjacent axial sections. For example, the second annular axial wall 40 may have a diameter greater than a diameter of respective first and third axial walls 38, 42 which may have a diameter equal to or different one from the other, and a fourth annular axial wall 44 may have a diameter smaller than the diameter of the third annular axial wall 42.

Optionally, the radial dimension between a radial inner edge and a radial outer edge of the respective forged steel rings 46, 48 and 50 may be greater than the diameter difference between the respective adjacent two of the annular axial walls 38, 40, 42 and 44 such that the radial outer edge of the respective forged steel rings 46, 48 may project radially outwardly from the second annular axial wall 40 and the radial outer edge of the forged steel ring 50 may project radially outwardly from the third annular axial wall 42. The radially extending forged steel rings may each be formed as a flat ring such as the forged steel rings 46, 48, shown in FIG. 3. Alternatively, the axially extending forged steel rings may each be formed with a radial outer portion and a radial inner portion axially offset one from another and interconnected by a very small annular axial portion, such as the forged steel ring 50 in FIG. 3.

Optionally, the thin-walled steel support structure shell 28 may be further provided with a radially extending front forged steel ring 52 secured to and extending radially outwardly from a forward end of the first annular axial wall 38 which is also a forward end of the steel support structure shell 28 and a radially extending aft forged steel ring 54 secured to and extending radially and outwardly from an aft end of the fourth annular axial wall 44 which is also the aft end of the steel support structure shell 28. The front and aft forged steel rings 52, 54 may provide a mounting device for connecting the fan case 28 to a nacelle casing of the engine 10 and may also enhance the stiffness and strength of the fan case 20.

Optionally, the annular axial walls 38, 40, 42 and 44 may have an equal thickness (made from sheet metal having the same thickness) or may have different thicknesses (made from sheet metal having different thickness within the range between 0.02 and 0.07 inches).

An annular chamber may be formed on a radially inner circumference 56 of the second annular axial wall 40 and may axially extend between the radially extending forged steel rings 46 and 48 for receiving the honeycomb material 30a such as a filler-structure honeycomb material. “Filler-structure honeycomb material” is a honeycomb material sandwiched between two members in order to provide structural stability of the assembly compared to an empty cavity. In this case the honeycomb sandwich provides stability of the case before and after the fan blade off (FBO) event. Before the event it provides dimensional stability of the case 20 and after the event holds the damaged shell structure together under the inward tension of the KEVLAR wrap. The blade fragments usually pass through the steel support structure shell 28 and contained by the KEVLAR wrap 32 or outer containment fabric layer 32. Therefore the damaged steel support structure shell 28 is prone to collapse under the inward tension of the KEVLAR, the filler structure provides support for the KEVLAR wrap or outer containment fabric layer 32. The honeycomb material 30a may completely fill the chamber and may be sealed therein by the annular metallic inner axial wall 34. The honeycomb material 30a may extend continuously from the forged steel ring 46 to the forged steel ring 48, thereby fully axially spanning the tips of the blades 22. The honeycomb material 30a may be bonded or otherwise suitably secured to the radially inner circumference 56 of the second annular axial wall 40 and a radially outer side 58 of the annular metallic inner axial wall 34. The annular metallic inner axial wall 34 may also be bonded or otherwise secured to the first and second annular axial walls 38 and 42 or to the forged steel rings 46, 48 of the steel support structure shell 28. The thin-walled steel support structure shell 28, the honeycomb material 30a and the annular metallic inner axial wall 34 are thus structurally integrated with one another, forming a structure with the honeycomb material 30a sandwiched between the second annular axial wall 40 of sheet metal and the annular metallic inner axial wall 34. Therefore, the honeycomb material 30a not only provides for small blade fragment retention and kinetic energy absorption but also plays a structural role in contributing to stiffen/reinforce the fan case assembly in addition to the structural stiffness and strength provided by the thin-walled steel support structure shell 28 of sheet metal reinforced by the forged steel rings 46, 48, 50, 52, 54. U.S. Pat. No. 8,202,041 issued on Jun. 19, 2012 which is incorporated herein by reference, describes a structure of a honeycomb material sandwiched between metallic shells.

Optionally, further honeycomb materials 30b, 30c such as filler-structure honeycomb materials, and honeycomb materials 30d, 30e such as acoustic honeycomb materials may be added within the steel support structure shell 28 for example, and may be bonded or otherwise suitably secured to radially inner sides 62, 60 and 64 of the respective first annular axial wall 38, annular metallic inner axial wall 34 and third annular axial wall 42. The honeycomb materials 30b, 30c, 30d, and 30e may continuously extend axially from the forward end of the first annular axial wall 38 to the forged steel ring 50, in order to further provide energy absorption during a fan blade off (FBO) event as well as to contribute to stiffen the fan case 20. The honeycomb materials 30a, 30b, 30c, 30d and 30e may be structurally integrated with the annular metallic inner axial wall 34 to form a honeycomb material layer within which the annular metallic inner axial wall 34 is embedded.

As mentioned above, the honeycomb material layer may include the acoustic honeycomb materials 30d, 30e (for instance a honeycomb foam composite material) which also provide acoustic damping. The acoustic honeycomb materials 30d and 30e may be axially positioned afore and after the blades 22, respectively, and radially inner sides 66, 68 of the respective acoustic honeycomb materials 30d, 30e may constitute part of the radially innermost surface of the fan case 20. An abradable tip clearance control layer 70 may be provided on the radially inner side of the filler-structure honeycomb material 30b such that the abradable tip clearance control layer 70 is axially positioned between the radially inner sides 66, 68 of the respective acoustic honeycomb materials 30d and 30e, and is axially aligned with the tips of the blades 22 in order to enable close clearances between the blade tips and the radially innermost surface of the fan case 20. The radially innermost surface of the fan case 20 formed by the abradable layer 70 and the radially inner sides 66, 68 of the acoustic honeycomb materials 30d, 30e therefore form an axially continuous flow boundary surface of the fan case 20 for the incoming air. U.S. Pat. No. 8,202,041 issued on Jun. 19, 2012 which is incorporated herein by reference, also describes an abradable tip clearance control layer.

The outer containment fabric layer 32 wrapped around the second annular axial wall 40 may extend axially between the forged steel rings 46 and 48 and may be constructed of aromatic polyamide fabric such as KEVLAR, which has a relatively light weight and high strength. Other light-strength woven fibrous materials (e.g. ballistic type fabrics) could be used as well. Any suitable reinforcing fibers can be used to form the outer blade containment ring, including but not limited to, glass fibers, graphite fibers, carbon fibers, ceramic fibers, etc. U.S. Pat. No. 8,202,041 issued on Jun. 19, 2012 which is incorporated herein by reference, describes such fabric materials.

The present disclosure is directed to a bi-material shell 80 with embedded fuse lines as a protective shell around the outer containment fabric layer 32 or softwall KEVLAR belt 32. As illustrated, the bi-material shell 80 is radially outward with respect to belt 32. The bi-material shell 80 wraps around the entire periphery of the fan case 20 and surrounds the outer containment fabric layer 32 or softwall KEVLAR belt 32, which also wraps around the entire periphery of the fan case 20.

The bi-material shell 80 is formed from a plurality of bi-material shell segments 81, which are each independently formed by for example, a curing process, and then secured around the outer containment fabric layer 32 or softwall KEVLAR belt 32. For example, each one of the plurality of bi-material shell segments 81 when formed provide a curved or arced portion of the 360 degrees of the bi-material shell 80 secured around the outer containment fabric layer 32 or softwall KEVLAR belt 32. For example, and as illustrated in at least FIGS. 2A and 2B, each shell segment 81 in one non-limiting example, may form 90 degrees of the 360 degrees of the bi-material shell 80. Of course, the length of the segments may vary to be greater or less than 90 degrees (e.g., 180 degrees (two segments 81 used) or 45 degrees (8 segments used) or any other combination or length of the segment).

Each bi-material shell segment 81 includes at least an inner layer 82 and an outer layer 84. The inner layer 82 being radially inner respect to the outer layer 84. In other words, the inner layer 82 is closer to the central axis 26 of the engine 10 as opposed to the outer layer 84 when the bi-material shell segment 81 is secured to the fan case 20. A flexible, relatively weak, but easily bonded material (such as a polyvinyl fluoride or Tedlar) forms the inner layer 82 of the bi-material shell segment 81, and a plurality of individual segments 85 of a strong, hard, repairable, aesthetically pleasing material (such as carbon fiber reinforced polymer (CFRP) or any other long fiber reinforced polymer) forms the outer layer 84 of the bi-material shell segment 81. As used herein a carbon fiber reinforced polymer (CFRP) or any other long fiber reinforced polymer may be referred to as a composite material. In one embodiment, one or both of the materials for the inner layer 82 and the outer layer 84 is desired to be waterproof (Tedlar) and tolerant to ultraviolet light (CFRP). The inner layer 82 of each bi-material shell segment 81 is predominantly continuous (e.g., a single unitary layer). Alternatively, if multiple segments are used for the inner layer 82 of each bi-material shell segment 81 these segments of the inner layer 82 of each bi-material shell segment 81 will contain lap joints.

The outer layer 84 of each bi-material shell segment 81 is formed by a plurality of individual segments 85 that when arranged next to each other on top of the inner layer 82 define a plurality intentionally weak fuse lines 86 using butt joints or alternatively lap joints that provide a relatively small overlap. Then the bi-material shell segment 81 is formed by for example a curing process. In one non-limiting embodiment and when the lap joints are used, the overlap of the lap joint of each segment 85 of each bi-material shell segment 81 is approximately 0.1 inches.

In one non-limiting embodiment, the plurality intentionally weak fuse lines 86 are embedded in the outer layer 84 of each bi-material shell segment 81 or formed therein and the plurality intentionally weak fuse lines or fuse lines 86 are defined by anyone of the following; butt joints between the plurality of segments 85 of the outer layer 84 of each bi-material shell segment 81, overlap joints between the plurality of segments 85 of the outer layer 84 of each bi-material shell segment 81, fiber discontinuities between the plurality of segments 85 of the outer layer 84 of each bi-material shell segment 81 or combinations thereof.

In one non-limiting embodiment and if the outer layer 84 of each bi-material shell segment 81 is more than one layer thick (e.g., layers of segments 85 placed on top of each other), then the butt joints would be configured to align closely through the layers (within 0.1 inches or so) so that the butt joints are generally aligned. Because there are no continuous strong materials such as carbon fibers transversing the joints 86 of each bi-material shell segment 81, the joints 86 act as intentionally weak features in of each bi-material shell segment 81 of the bi-material shell 80, even while the entire surface is covered in the durable, damage resistant material of the segments 85. The fuse lines 86 of each bi-material shell segment 81 are designed such that the overall structure of the protective bi-material shell 80 does not impede the rapid expansion of the KEVLAR 32 or outer containment fabric layer 32 under fan blade (FBO) loading. In one non-limiting alternative configuration and if there are overlap joints between the plurality of segments 85 of the outer layer 84 the relatively small overlap (e.g., approximately 0.1 inches of the adjacent segments 85 including any carbon fibers would not impede the operation of the fuse lines 86 (e.g. separation of the adjacent segments 85 during for example, a fan blade off event).

Several such fuse line 86 patterns of each bi-material shell segment 81 are shown in FIGS. 4-15, pictured in a planar state or prior to being formed into the of each bi-material shell segments 81 illustrated in at least FIGS. 2A and 2B.

In accordance with one non-limiting embodiment of the present disclosure, the plurality of segments 85 of the outer layer 84 of each bi-material shell segment 81 are bonded together after their formation during for example, a curing process or any other functionally equivalent forming/hardening/solidifying process of each bi-material shell segment 81. For example, the protective bi-material shell 80, and as mentioned above the protective bi-material shell 80, may be composed of 4 bi-material shell segments 81 which are cured separately, each with embedded fuse lines 86, each spanning at least 90 degrees. After curing, these 4 segments of bi-material shell segments 81 are assembled together around the Kevlar or outer containment fabric layer 32 on the fan case by bonding and/or mechanically securing them to their neighboring shell segments 81 at their ends or connection points 89.

Referring now to FIGS. 2C and 2D, non-limiting alternatives of bonding and/or mechanically securing neighboring shell segments 81 to each other at their ends or connection points 89. In FIG. 2C one end of one of the neighboring shell segments 81 overlaps the other and in FIG. 2D the ends of the neighboring shell segments 81 are formed to have flanges or flange portions 91 that are mechanically secured to each other via fasteners and/or the flanges or flange portions 91 are bonded or secured to each other with an adhesive.

The use of a material like carbon fiber on the outside or radial outer surface of the outer layer 84 of each bi-material shell segments 81 is visually appealing and enables the use of carbon fiber tape for repairs, which visually blends with the surrounding material more easily than the repair tape for the PTFE.

In one non-limiting embodiment, the bi-material shell segments 81 of the bi-material shell 80 could be implemented in a segmented design where the segments 81 are replaceable in the field.

Wavy or zig zag fuse lines 86 (such as those at in FIG. 9) can be utilized to minimize the hazard of handling damage in bending before assembly while limiting the tensile capability of the bi-material shell 80 under fan blade off (FBO). This may be necessary if the bi-material shell 80 does not have significant axial profiling, resulting in a low second moment of area, while also having minimal segments around the circumference.

Referring now to FIGS. 10-15, an alternative embodiment is illustrated. Here the fiber orientation illustrated by the dashed lines for a carbon fiber reinforced polymer (CFRP) segment 85 of the outer layer 84 of each of the bi-material shell segments 81 of the bi-material shell 80 could be selected or tuned to work with the fuse pattern such that the fuse lines 86 minimize a longest fiber length of each segment 85 while minimizing the number of segments 85. Typical fabric composites have two fiber directions, the orientation with the lowest maximum fiber length depends on the fuse line 86 pattern. For example, if the segments 85 form squares, the fibers should align with the edges of the squares to achieve the lowest maximum fiber length. However, if the segments 85 form long rectangles, the fibers should be laid up at a 45 degree angle from the long edge of the rectangle to minimize the maximum fiber length. As such, at least the aforementioned fiber orientations and illustrated fiber orientations may be used to minimize the maximum fiber length while also minimizing the number of segments 85. Note: only some of the fiber orientations are illustrated by the dashed lines in FIGS. 10-15. Generally, this can be achieved by orienting the fibers at 45 degrees to parallel fuse lines 86.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A casing for a gas turbine engine, comprising:
a containment fabric layer wrapped around a structural shell; and
a bi-material shell located around the containment fabric layer, the bi-material shell formed from a plurality of bi-material shell segments, each of the plurality of bi-material shell segments include an inner layer and an outer layer, the outer layer comprises a plurality of individual segments that form the outer layer and a plurality of embedded fuse lines defined by the plurality of individual segments of the outer layer, wherein an overall structure of the bi-material shell does not impede a rapid expansion of the containment fabric layer.

2. The casing as in claim 1, wherein the inner layer of each of the plurality of bi-material shell segments is continuous.

3. The casing as in claim 1, wherein the inner layer of each of the plurality of bi-material shell segments contains lap joints.

4. The casing as in claim 1, wherein the plurality of embedded fuse lines are defined by anyone of the following; butt joints between the plurality of individual segments that form the outer layer, overlap joints between the plurality of individual segments that form the outer layer, fiber discontinuities between the plurality of individual segments that form the outer layer or combinations thereof.

5. The casing as in claim 4, wherein the inner layer comprises polyvinyl fluoride and the plurality of individual segments that form the outer layer are carbon fiber-reinforced polymer segments.

6. The casing as in claim 4, wherein the plurality of embedded fuse lines are defined by wavy lines.

7. The casing as in claim 4, wherein the plurality of embedded fuse lines are defined by zig zag fuse lines.

8. The casing as in claim 5, wherein a fiber orientation of each of the plurality of individual segments that form the outer layer minimize a longest fiber length while minimizing a number of the plurality of individual segments.

9. The casing as in claim 5, wherein a fiber orientation of each of the plurality of individual segments that form the outer layer are 45 degrees to parallel fuse lines.

10. The casing as in claim 1, wherein the casing is a fan casing.

11. A gas turbine engine, comprising:
a fan having a plurality of fan blades;
a casing surrounding the plurality of fan blades, the casing comprising:
a containment fabric layer wrapped around a structural shell; and
a bi-material shell located around the containment fabric layer, the bi-material shell formed from a plurality of bi-material shell segments, each of the plurality of bi-material shell segments include an inner layer and an outer layer, the outer layer comprises a plurality of individual segments that form the outer layer and a plurality of embedded fuse lines defined by the plurality of individual segments of the outer layer, wherein an overall structure of the bi-material shell does not impede a rapid expansion of the containment fabric layer.

12. The gas turbine engine as in claim 11, wherein the inner layer of each of the plurality of bi-material shell segments is continuous.

13. The gas turbine engine as in claim 11, wherein the inner layer of each of the plurality of bi-material shell segments contains lap joints.

14. The gas turbine engine as in claim 11, wherein the plurality embedded fuse lines are defined by anyone of the following; butt joints between the plurality of individual segments that form the outer layer, overlap joints between the plurality of individual segments the form the outer layer, fiber discontinuities between the plurality of individual segments that form the outer layer or combinations thereof.

15. The gas turbine engine as in claim 14, wherein the inner layer comprises polyvinyl fluoride and the plurality of individual segments that form the outer layer are carbon fiber-reinforced polymer segments.

16. The gas turbine engine as in claim 14, wherein the plurality of embedded fuse lines are defined by wavy lines.

17. The gas turbine engine as in claim 14, wherein the plurality of embedded fuse lines are defined by zig zag fuse lines.

18. The gas turbine engine as in claim 15, wherein a fiber orientation of each of the plurality of individual segments that form the outer layer minimize a longest fiber length while minimizing a number of the plurality of individual segments.

19. The gas turbine engine as in claim 15, wherein a fiber orientation of each of the plurality of individual segments that form the outer layer are 45 degrees to parallel fuse lines.
